(19) United States
(12) Patent Application Publication
(10) Pub. No.: US 2006/0060622 A1
(43) Pub. Date: Mar. 23, 2006

(54) Vehicle mounted bicycle carrier

(76) Inventor: Jeff Prenger, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/947,989

(22) Filed: Sep. 23, 2004

(51) Int. Cl. B60R 11/00

(52) U.S. Cl. 224/502; 224/924

(57) ABSTRACT

A modular bicycle carrier is configured to support one or more bicycles for transport by a vehicle such as a bus. The carrier includes a frame and at least one bike mount, the bike mount detachably connected to the frame so that it may be removed. The frame includes mounts configured to permit the carrier to be moved between a raised, stowed position and a lowered, use position. In one embodiment, each bike mount is supported by a support which is connected to the frame by a fastener. Another embodiment of the invention is a method of repairing a prior art bicycle rack by severing support tubes of a bicycle to disconnect the mount and sliding supports of a new mount over severed portions of the original supports.

### FIELD OF THE INVENTION

The present invention relates to bicycle racks or carriers and, more particularly, such devices configured for mounting to public transportation vehicles.

### BACKGROUND OF THE INVENTION

Bicycles are a very popular form of transportation. Unfortunately, in some instances, such as for long commutes and in bad weather, bicycles are not practical.

Public transportation offers an alternative means for transport. In some instances, however, a bicycle rider may wish to combine public transportation with the use of their bicycle. The most common instance is where the rider needs to travel some distance from their home to the location of public transport, and/or some distance from their work to the location of public transport. For example, a rider may ride their bicycle some distance from their home to a bus stop. The rider may then ride some distance from a bus stop near their office to their office and, of course, repeat those steps returning home from work.

In order to accommodate the needs of these riders, many public transportation agencies have added bicycle racks to their buses or other vehicles. This allows a rider to transport their bike while riding the public transportation.

Unfortunately, public transportation agencies are not experienced in the design and maintenance of these racks. As such, they are forced to purchase them from a few select companies that offer the racks. The agencies have found, however, that there are many disadvantages to the racks which are currently offered.

For example, Sportworks Northwest, Inc. offers a bus-mountable bicycle rack. One design of such a rack is illustrated in U.S. Pat. No. 5,692,569. This rack has several disadvantages. First and foremost, the supporting structure of the rack is essentially a unitary structure, comprising bicycle supporting tubes which are welded to supporting frame elements.

Unfortunately, because these racks are mounted at the front of buses, they are frequently damaged. Among other things, bicycle supporting tubes extend towards the periphery of the bus. The tubes often hit curbs or similar elements, and are damaged. Currently, when these racks are damaged in this manner, transportation agencies must generally retire the rack and purchase a new rack. This is extremely expensive and a deterrent to transportation agencies offering bike racks as part of their services.

Other aspects of the design suffer from disadvantages. For example, a stated requirement of some public transportation agencies for the safety of their riders is that any rack should be useable by a rider without the rider having to step in front of the bus in order to place and secure their bicycle. The above-stated design generally does not meet this requirement. In particular, a release handle for lowering the rack into a useable position is located centrally to the rack, thus requiring the user to travel to the front of the rack to lower it.

### SUMMARY OF THE INVENTION

The invention is a bicycle carrier configured to be mounted to a vehicle such as a bus, for transporting one or more bicycles.

In one embodiment, the carrier is of a modular design and is configured for connection and transport by a vehicle. The carrier comprises a frame and at least one bicycle mount which is selectively connectable/disconnectable to the frame.

In one embodiment, the frame comprises a pair of spaced supports, the supports configured to be connected to a vehicle. The frame may include one or more struts or supporting elements connecting the supports.

In one embodiment, each bicycle mount comprises a pair of spaced rails. The rails are connected at their ends by a pair of stops. At least one intermediate stop is positioned along the rails for limiting the position of bicycle wheel along the rails. In addition, each bicycle mount includes at least one tire or wheel support for supporting a tire or wheel thereon.

Preferably, each bicycle mount is supported by a plurality of mount supports. The mount supports are selectively connectable to the frame. In one embodiment, each mount support comprises a downwardly extending tube having an internal threaded passage. A fastener extends through the frame into engagement with the threaded passage of the tube.

In one embodiment, the carrier is configured to be moved between a raised, stowed position and a lowered, use position. In one embodiment, the frame includes one or more pivot mounts, each mount including an aperture for accepting a pin therethrough, the pivot mount permitted to rotate about the pin. In one embodiment, means are provided for aiding the carrier in movement between its two positions. A hydraulic piston is connected at one end to the carrier and at the other end to the vehicle.

The carrier of the invention is designed so that it may be easily assembled and disassembled, such as for repair. For example, if a bike mount is damaged, it may be easily disconnected from the frame and replaced with a new mount.

Another embodiment of the invention comprises a method of repairing a damaged rack in accordance with the prior art and apparatus for repairing such a rack. Preferably, the method is applicable to racks having bicycle mounts which are permanently attached to a supporting frame, such as by supports which are welded to the frame.

In accordance with the method, the supports are severed to disassociate the mount from the frame. Preferably, the supports are severed so that a severed portion remains extending from the frame.

A new mount is provided, the mount including support tubes, the tubes designed to accept at least a portion of the severed portions of the supports. The mount is lowered onto the rack so that the severed portions of the supports extend into the corresponding tubes. The tubes are then connected to the severed supports, such as with fasteners.

In a preferred embodiment, the tubes are hollow cylinders. The length of each tube is selected so that a free end rests upon the frame when the tubes are located over the severed supports.

In accordance with this aspect of the invention, a damaged rack may be repaired.

Further objects, features, and advantages of the present invention over the prior art will become apparent from the detailed description of the drawings which follows, when considered with the attached figures.

### DESCRIPTION OF THE DRAWINGS

FIG. 1 is a first perspective view of a carrier of the present invention;

FIG. 2 is a second perspective view of the carrier illustrated in FIG. 1;

FIG. 3 is an end view of the carrier illustrated in FIG. 1;

FIG. 4 illustrates a portion of a bicycle rack in accordance with the prior art; and

FIGS. 5-7 illustrate a method of replacing a rail of the bicycle rack illustrated in FIG. 4.

### DETAILED DESCRIPTION OF THE INVENTION

The invention is a carrier or rack particularly configured to transport one or more bicycles by connection to a vehicle. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a bicycle carrier or rack. The carrier is configured to be associated with a vehicle, such as a bus. The carrier is configured to support one or more bicycles for transport by the vehicle. The carrier is of a modular design, permitting it to be disassembled in whole or in part, including for repair.

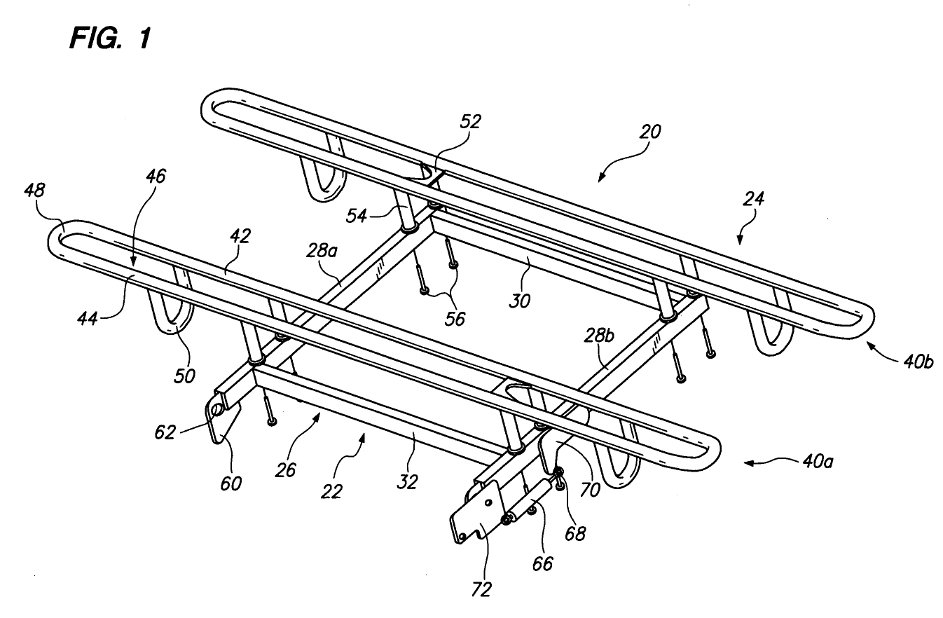

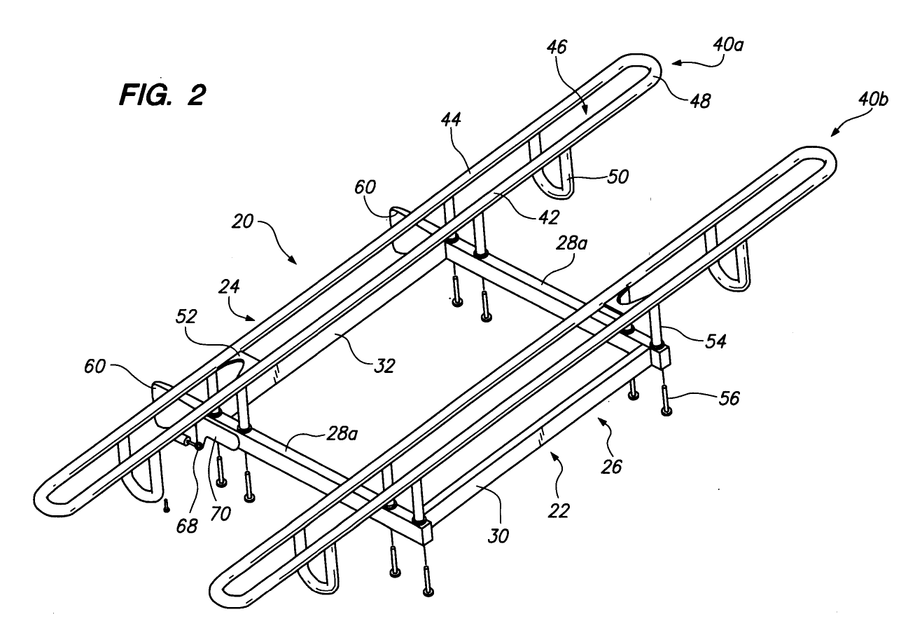

FIGS. 1 and 2 illustrate a bicycle carrier 20 in accordance with one embodiment of the invention. The carrier 20 includes a frame 22. The frame 22 is preferably configured to be mounted to a vehicle, such as a public transportation vehicle and, most preferably, a bus. The carrier 20 may be configured to be connected or supported by a variety of other vehicles.

As illustrated, the frame 22 has a first or mounting portion 24, and second or supporting portion 26. In one embodiment, the frame 22 comprises a pair of spaced supports 28. In one embodiment, to increase the strength and ridigity of the frame 22, a pair of struts 30,32 span and connect the supports 28.

In one embodiment, the supports 28 and struts 30,32 comprise metal tubing. For example these components might comprise square or round metal tubing.

As illustrated, each support 28 has a first end and an opposing second end. The first or mounting portion 24 of the frame 22 includes the first ends of the supports 28. As best illustrated in FIG. 2, each support 28a,b preferably has a mount located at its first end. In one embodiment, the mount comprises a mounting plate 60 having one or more passages 62 therethrough for accepting a fastener. This permits each mounting plate 60 to be connected, such as with one or more bolts, to the desired support, such as the front of a bus. Of course, the mounts 34 may have a variety of other shapes and configuration other than as illustrated and described. In addition, while in one embodiment the mounts are plates which are connected, such as with welding or fasteners, to the supports 28, the supports could themselves define the mounts. Additional aspects of a preferred mounting configuration of the carrier 20 are detailed below.

In one embodiment, a first of the struts 30 is located along the supports 28 between their first and second ends. Preferably, this strut 30 is located sufficiently inwardly that it does not interfere with the vehicle or other device to which the frame 22 is connected.

As illustrated, the second of the struts 32 is located near the second ends of the supports 28.

The struts 30,32 including their number and location, could vary. Further, the frame 22 may have a variety of other configurations, including additional or lesser supports, struts or other elements. For example, the frame 22 might use cross-bracing.

The carrier 20 also includes one or more bicycle mounts 40a,b. In the embodiment illustrated, the carrier 20 includes two bicycle mounts 40a,b. The carrier 20 might include only a single bicycle mount or might include more than two bicycle mounts.

Preferably, each bicycle mount 40a,b is configured to support and engage the wheels of a bicycle. As illustrated, each mount 40a,b comprises a pair of spaced rails 42,44. Preferably, the rails 42,44 define a slot 46 therebetween which is just sufficiently wide to accept the tires and wheels of most standard bicycles.

The rails 42,44 are preferably sufficiently long that the length of the slot 46 slightly exceeds the distance from the front of the front wheel to the back of the rear wheel of most standard bicycles.

Preferably, each mount 40a,b includes a stop 48 at each end of the rails 42,44. As illustrated, each stop 48 is “U”-shaped. In one embodiment, the stops 48 may be an integral portion of one or both rails 42,44 or the member(s) that form the rails 42,44. The stops 48 effectively terminate the slots 46 between the rails 42,44 of each mount 40a,b.

Each mount 40a,b includes at least one tire or wheel support 50. As illustrated, each mount 40a,b includes a pair of tire or wheel supports 50, one corresponding to the front tire/wheel and one corresponding to the rear tire/wheel of a bicycle. In one embodiment, each tire or wheel support 50 comprises a “U”-shaped support which is connected to, and extends below, the rails 42,44. As described below, a bottom portion of each tire support 50 is preferably located sufficiently below the rails 42,44 that when a bicycle tire is engaged by the mount 40a,b, the rails 42,44 engage the tires/wheels of the bicycle upwardly from their lowest point.

In one embodiment, the mounts 40a,b include an intermediate stop 52. The intermediate stop 52 is positioned along the rails 42,44 between the stops 48 at the ends of the rails 42,44. In a preferred embodiment, the intermediate stop 52 is positioned nearer one or the stops 48 than the other. Preferably, the distance between the intermediate stop 52 and the closest end stop 48 is slightly greater than a distance spanning a tire/wheel of a bicycle when located in the mount 40 and resting upon the tire or wheel support 50.

In one embodiment, the intermediate stop 52 is preferably configured to engage a tire/wheel of a bicycle and limit the positioning of a tire or its movement, to a portion of the mount 40. As illustrated, each intermediate stop 52 includes a trough or cut-out area 54. Preferably, sides of the trough are non-parallel. In one embodiment, the trough has a “V” or “U”-shape. In this configuration, the sides are configured to engage a tires/wheels having differing widths.

In a preferred configuration, the mounts 40a,b are oriented in alternating positions with respect to one another. Thus, where there are two mounts 40a,b, the mounts 40a,b are oriented in reverse to one another.

In one embodiment, the intermediate stop 52 of each mount 40a,b is configured to engage the front tire/wheel of a bicycle. In the configuration where the mounts 40a,b are located in reversed positions, the intermediate stops 52 of the two mounts 40a,b are thus offset from one other, such that one mount 40a is configured to accept the front tire/wheel of a bicycle at the left side thereof (when viewing the carrier 20 in the direction illustrated in FIG. 1) and the other mount 40b is configured to accept the front tire/wheel of a bicycle at the right side there (when viewing the carrier 20 in that same direction).

Most importantly, the carrier 20 is configured to be modular in design. As such, in a preferred embodiment, the mounts 40a,b are configured to be movably connected to the frame 22.

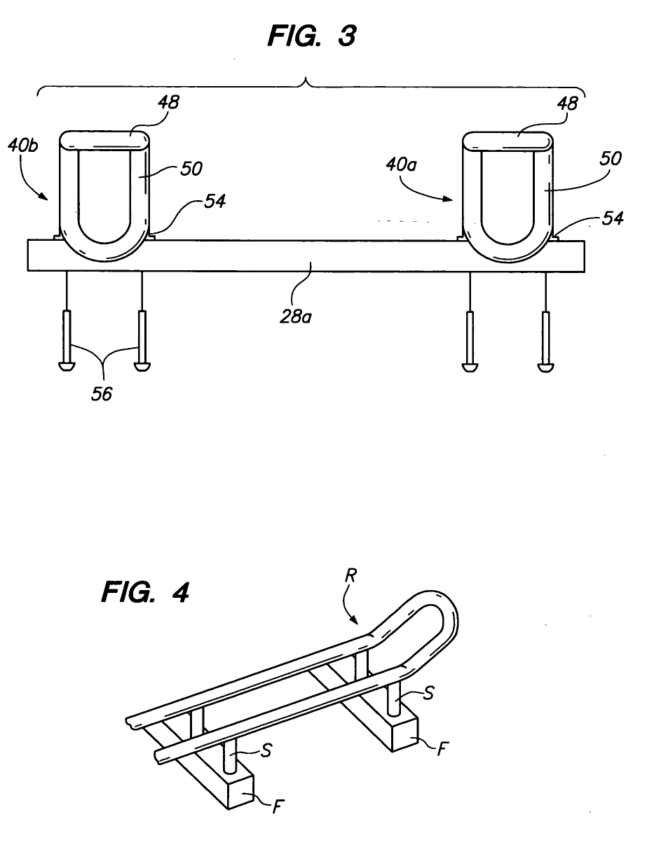

Referring to FIGS. 1-3, each mount 40a,b is connected to the frame 22 by one or more legs 54 or other supports. In one embodiment, each mount 40a,b, and preferably each rail 42,44 of each mount 40a,b, is supported by a leg 54. Thus, as illustrated, each mount 54 is preferably supported by four legs 54.

In one embodiment, each leg 54 is connected to its corresponding rail 42,44, such as by welding. The legs 54 may be configured to be detached from their corresponding rails 42,44.

In a preferred embodiment, each leg 54 is configured to be detachably connected to the frame 22. In one embodiment, the legs 54 are configured to accept fasteners 56. In one embodiment, each leg 54 has an opening at a bottom end. At least a portion of the opening is preferably threaded for accepting a threaded fasteners 56. For example, in one embodiment, each leg 54 comprises a generally hollow tube. A nut is fixed within the leg 54 for mating with a bolt.

As illustrated, the fasteners 56 pass through apertures in the frame 22. In the embodiment illustrated, the mounts 40a,b connect to the supports 28a,b of the frame 22. The apertures extend from the bottom through to the top of each support 28a,b.

Of course, the mounts 40a,b may be detachably connected to the frame 22 in other ways. For example, studs may extend upwardly from the frame 22. The legs 54 may be configured to engage those studs. In one embodiment, the legs might include rotatable nuts for locking to the studs. The mounts 40a,b might be connected in other manners, such as with “U” bolts, straps or other elements which preferably allow the mounts 40a,b to be disconnected from the frame 22.

In a preferred embodiment, the carrier 20 is configured so that it may be transported in a raised or stowed position and in a lowered or use position. In the raised position, the carrier 20 preferably extends in a generally vertical direction, such as against the front of a bus. In the lowered position, the carrier 20 preferably extends in a generally horizontal direction, such as illustrated in FIGS. 1 and 2. In this position, the carrier 20 is oriented to accept and transport one or more bicycles.

As described briefly above, in one embodiment, the mount portion 24 of each support 28a,b includes a pivot plate 60. The plate 60 defines an aperture 62. A pin, such as a bolt (not shown) is preferably passed through each pivot plate 60 into engagement with the vehicle. The aperture 62 in each pivot plate 60 is preferably larger than the pin, whereby the pivot plate 60 may rotate about its respective pin. In this manner, the carrier 20 may be rotated between its raised and lowered positions.

In one embodiment, means are provided for generally maintaining the carrier 20 in its raised or lowered position, and aiding in moving the carrier 20 from one to the other position. In one embodiment, this means comprises a piston 64. As illustrated, the piston 64 comprises a hydraulic piston having a body 66 and an extendable/retractable arm 68. Such pistons are well known.

One end of the arm 68 of the piston 64 is connected to the carrier 20. In one embodiment, the arm 68 is connected to a mounting plate 70 which is connected to one of the supports 28a. The arm 68 could be directly connected to the support 28a or another portion of the carrier 20, or by other mounts.

The body 66 of the piston 64 is preferably connected to another mounting plate 72. This mounting plate 72 is configured for connection to a support structure, and preferably the vehicle to which the carrier 20 is mounted.

In one embodiment, the carrier 20 may include means for engaging a bicycle which is supported thereby, thus ensuring that the bicycle does not inadvertently become disassociated with the carrier. For example, the carrier 20 may include one or more engaging members which prevent a bicycle from bouncing out of engagement with the bike mounts 40a,b.

The carrier 20 of the invention has numerous advantages. First and foremost, the carrier is modular. As described, the bike mounts 40a,b are designed to be disconnected from the frame 22. Thus, the carrier 20 may be selectively configured to include only one bike mount by simply not connecting the other mount. Further, in the event of damage to a bike mount, the bike mount may easily be disconnected from the frame. The bike mount may then be repaired or replaced entirely. Similarly, if the frame is damaged but not the bike mounts, the bike mounts may be disconnected and mounted to a new frame.

Importantly, the carrier is configured so that a user may easily move the rack between its raised position and its lowered position for use from the side of the carrier. This permits, in the case where the carrier is connected to a bus, the user to raise and lower the carrier from a sidewalk or curb area which is adjacent the bus.

In particular, the carrier 20 is configured so that, by gripping the carrier 20 from only the end (such as at the stop of the outer-most mount 40b), a user may easily raise or lower the carrier. In the preferred configuration, the piston aids in providing the force necessary to raise or lower the carrier.

Various other configurations of the carrier 20 are contemplated. For example, in one embodiment, the mounts 40a,b, may be “V”-shaped troughs for accepting the tires/wheels of a bicycle. In another embodiment, rails 42,44 may be provided, but the rails may be of other shapes and configurations. For example, the rails 42,44 might comprise flat rails which define a generally rectangular opening.

The tire or wheel supports 50 may comprise other elements than the “U”-shaped elements illustrated. For example, the supports might comprise generally flat plates upon which the tires may rest, a “V”-shaped trough or other elements. In general, the supports 50 may comprise any element(s) configured to provide vertical support to the tire/wheel.

Other mounts may be provided. For example, in one embodiment, two “levels” of rails may be provided, one above the other. In this fashion, the tires/wheels of the bicycle may be supported at more than one point in the vertical direction. The mounts might also comprise “U” shaped troughs, one for each wheel, each trough curved to extend around and engage a portion of the circumference of the tire/wheel.

It will be appreciated that the carrier 20 may be configured to carry bicycles of various types, and even other equipments. For example, the mounts 40a,b are preferably configured to accept the narrow tires (and associated wheels) of a road or racing cycle or the much wider tires (and associated wheels) of a mountain bicycle.

Another aspect of the invention is illustrated in FIGS. 4-7. One embodiment of the invention is a bike mount and a method of replacing a bike mount of an existing bicycle rack or carrier.

FIG. 4 illustrates a bicycle rack in accordance with a prior art design in which a support rail R is connected by a plurality of supports S to a frame F. The supports S may be integrally formed with the frame F and/or rails R, or may be welded or otherwise permanently connected thereto.

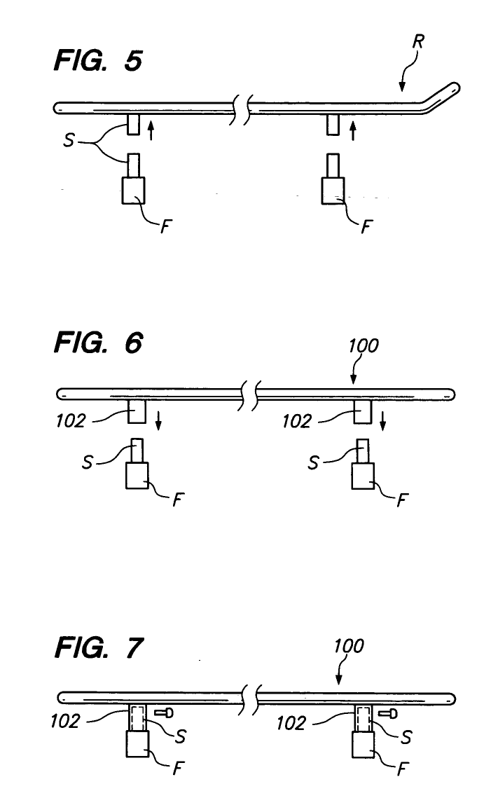

In the event the rail R needs to be replaced, such as in the case of damage, the supports S are severed, as illustrated in FIG. 5. For example, an acetylene torch, metal saw or the like may be used to cut the supports S, in the event the supports are constructed of metal. As illustrated, the supports S are preferably severed so that at least a portion of the support remains extending upwardly from the frame F. The damaged rail may then be disposed of or be repaired.

In accordance with the invention, as illustrated in FIG. 6, a replacement bike mount 100 is provided. The bike mount 100 may be similar to that illustrated in FIGS. 1 and 2, comprising spaced-apart members for supporting one or more wheels of a bicycle. Preferably, a plurality of tubes 102 extend downwardly from the bike mount 100. Each tube 102 is hollow, and sized (both when considering the inner diameter/dimension and length) to accept the terminated portion of the support S therein. In one embodiment, the length and diameter of each tube 102 is preselected, and the supports S are cut or severed so that the terminus portion which extends from the frame F will fit within the tube. In another embodiment, the tubes 102 could be customized to fit the severed supports S based upon the size and desired length of the supports S once severed.

Referring to FIG. 7, the bike mount 100 is lowered so that the tubes 102 extend over and accept therein the supports S. Preferably, free ends of the tubes 102 rest upon or engage the frame, providing a stable support for the bike mount 100. In order to secure the bike mount 100 to the frame F, one or more fasteners, such as screws or the like, may be extended through the tubes 102 into engagement with the supports S. Of course, other means of connection may be used, such as connecting pins, braces, brackets or the like.

In accordance with this method, a bicycle rail of rack of the prior art may be easily replaced without having to modify the entire rack. In this manner, an existing bicycle rack may easily be repaired instead of having to be destroyed.

In one embodiment, once a damaged rail is severed and removed, it may be repaired. Tubes may be connected to the rail and then the rail connected back to the frame in the manner just described above.

Variations of the method and apparatus just described are contemplated. First, the supports for the bike mount 100 need not comprise tubes which are closed cylinders. The tubes may have slots or openings therein, such as by comprising a spaced-apart leg members, and need not be semi-circular in shape. The tubes may comprises a variety of members which extend from the bike mount and which may be connected to the supports S.

In one embodiment, tubes may be provided corresponding to one or more but not all of the severed supports S. For example, it may be determined that a lesser number of tubes or other members may be used to connect the bike mount to the frame.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of repairing a bicycle rack having a frame with a bicycle support connected thereto by one or more supports comprising:
severing the supports connecting said bicycle rack to said frame, whereby a severed portion of said supports remain extending from said frame;
providing a replacement rail having a plurality of tubes extending therefrom, said tubes sized to accept at least a portion of said severed portion of said supports;
lowering said rail so that said tubes extend over at least a portion of said severed portion of said supports; and
securing said tubes to said severed portion of said supports.

2. The method in accordance with claim 1 wherein said tubes comprise generally hollow cylinders.

3. The method in accordance with claim 1 wherein said step of securing comprises passing at least one fastener through each tube into said severed support.

4. A modular bicycle carrier configured for connection and transport by a vehicle comprising:
a frame, said frame comprising a pair of spaced supports, said supports configured to be connected to a vehicle;
at least one bicycle mount, said bicycle mount comprising a pair of spaced rails and at least one tire support connected to said rails and supported by said rails; and
a plurality of bicycle mount supports, each support extending from said bicycle mount and having a free end, said free ends of said mount supports selectively connected to said frame.

5. The carrier in accordance with claim 4 wherein said free ends of said mount supports has a threaded passage extending into said mount support, and where a fastener extends through said frame into engagement with said threaded passage of each mount support.

6. The carrier in accordance with claim 4 wherein a pivot member is connected to each support, each pivot member configured to accept a support pin therethrough in a manner permitting said frame to be rotated relative to the vehicle to which said carrier is connected.

7. The carrier in accordance with claim 6 including means for aiding in the movement of said carrier from a raised to a lowered position.

8. The carrier in accordance with claim 7 wherein said means comprises a piston member, said piston member having one portion connected to said carrier.

9. The carrier in accordance with claim 8 wherein said piston member has a second portion connected to a mount configured to be connected to the vehicle to which said carrier is connected.

10. The carrier in accordance with claim 4 wherein a pair of bicycle mounts are connected to said frame.

11. The carrier in accordance with claim 4 wherein said rails of said bicycle mount have a first end and a second end and a stop mounted at each end.

12. The carrier in accordance with claim 11 wherein each bicycle mount includes at least one intermediate stop configured to confine a bicycle tire which is engaged by said mount to a specific portion of said bicycle mount.

13. The carrier in accordance with claim 12 wherein said intermediate stop defines a trough, said trough having a pair of non-parallel sides.
